(19) United States
(12) Patent Application Publication
(10) Pub. No.: US 2011/0261077 A1
(43) Pub. Date: Oct. 27, 2011

(54) SYSTEM AND METHOD FOR PROVIDING ZOOM FUNCTION FOR VISUAL OBJECTS DISPLAYED ON SCREEN

(75) Inventor: YI-LIN CHIU, Tu-Cheng (TW)

(73) Assignees: MASSACHUSETTS INSTITUTE OF TECHNOLOGY, Cambridge, MA (US); CHI MEI COMMUNICATION SYSTEMS, INC., Tu-Cheng City (TW)

(21) Appl. No.: 12/765,763

(22) Filed: Apr. 22, 2010

(51) Int. Cl. G09G 5/00

(52) U.S. Cl. 345/660

(57) ABSTRACT

A system and a method for providing a zoom function for visual objects displayed on a screen. The system provides a user interface showing the visual object. The system includes a detection unit and a zoom unit. The zoom function is completed by using a control object and the detection unit. The zoom unit generates a zoom-in effect on the visual object when the control object moves toward the detection unit. The zoom unit generates a zoom-out effect on the visual object when the control object moves away from the detection unit.

### BACKGROUND

1. Technical Field

The present disclosure relates to a system and a method for providing a zoom function for visual objects displayed on a screen.

2. Description of Related Art

Many electronic devices comprise a touch screen. These touch screens can be manipulated using fingers and/or styluses in order to activate or execute one or more functions of the electronic devices.

One feature available on a touch screen is the ability to zoom on a visual object displayed on the touch screen. However, providing such a function is expensive due to technical requirements of the touch screen.

### BRIEF DESCRIPTION OF THE DRAWINGS

FIG. 1 is a block diagram of an embodiment of a system that provides a zoom function for a visual object displayed on a screen.

FIG. 2 illustrates an exemplary operation for providing zoom function utilized in the system of FIG. 1.

FIG. 3 is a flowchart illustrating a method for providing zoom function of the present disclosure.

### DETAILED DESCRIPTION

In general, the word “unit” as used herein, refers to logic embodied in hardware or firmware, or to a collection of software instructions, written in a programming language, such as, for example, Java, C, or assembly. One or more software instructions in the unit may be integrated in firmware, such as an EPROM. It will be appreciated that module may comprise connected logic units, such as gates and flip-flops, and may comprise programmable units, such as programmable gate arrays or processors. The unit described herein may be implemented as either software and/or hardware unit and may be stored in any type of computer-readable medium or other computer storage device.

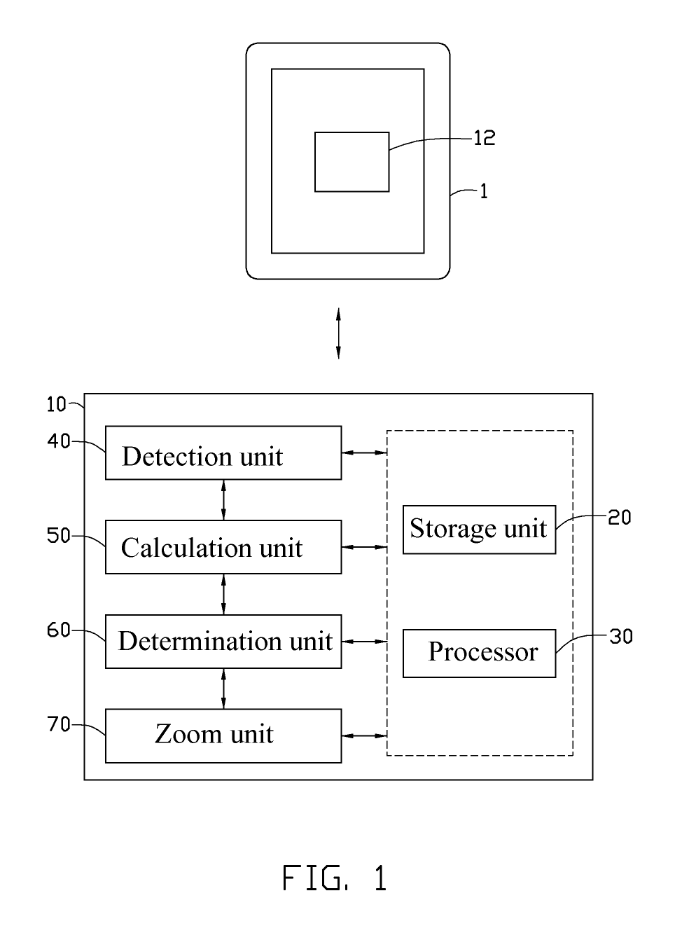

FIG. 1 is a block diagram of a system 10 that provides a zoom function for a visual object 12 displayed on a screen 1. The system 10 provides a user interface showing the visual object 12 on the screen 1. The system 10 includes a storage unit 20, a processor 30, a detection unit 40, a calculation unit 50, a determination unit 60, and a zoom unit 70. The processor 30 may execute one or more programs stored in the storage unit 20 to provide functions for the detection unit 40, the calculation units 50, the determination unit 60, and the zoom unit 70. The visual object 12 is an object that is displayed on the screen 1, and may comprise an image of a functional window of an electronic device, for example.

The system 10 is generally controlled and coordinated by an operating system, such as UNIX, Linux, Windows, Mac OS, an embedded operating system, or any other compatible system. Alternatively, the system 10 may be controlled by a proprietary operating system. Typical operating systems control and schedule computer processes for execution, perform memory management, provide file system, networking, and I/O services, and provide a user interface, such as a graphical user interface (GUI), among other tasks.

The detection unit 40 is operable to detect a control object 11 that is proximate to the system 10. The detection unit 40 may be a camera, a sonar system, or a proximity sensor, for example. The term, “control object” means an object that may be operated to control the system 10 for different programs. The control object 11 may be a finger, a palm of a person, or a pen, for example. In the embodiment, the detection unit 40 is a camera and the control object 11 is the palm of the person.

The calculation unit 50 is operable to calculate a first pixel number of a color area of the control object 11, and to calculate a second pixel number within a time interval after calculating the first pixel number, and to compare the second pixel number with the first pixel number. It should be understood that the color area is the area (e.g., square centimeters) of a determined color of a finger or a palm of a user.

The determination unit 60 is operable to determine that the control object 11 moves toward the detection unit 40 when the second pixel number exceeds the first pixel number, and that the control object 11 moves away from the detection unit 40 when the first pixel number exceeds the second pixel number.

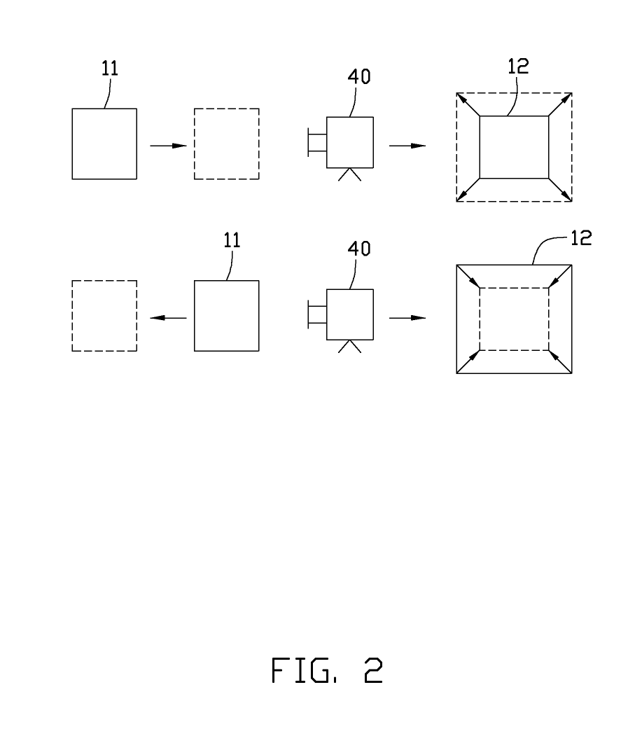

Referring to FIG. 1 and FIG. 2 at the same time, FIG. 2 illustrates a zoom function utilized in the system of FIG. 1 on the visual object 12 displayed on the screen 1. The zoom unit 70 generates a zoom-in effect the visual object 12 when the control object 11 moves toward the detection unit 40, and a zoom-out effect on the visual object 12 when the control object 11 moves away from the detection unit 40. The visual object 12 will be magnified and be made smaller due to the zoom-in effect and the zoom-out effect, respectively.

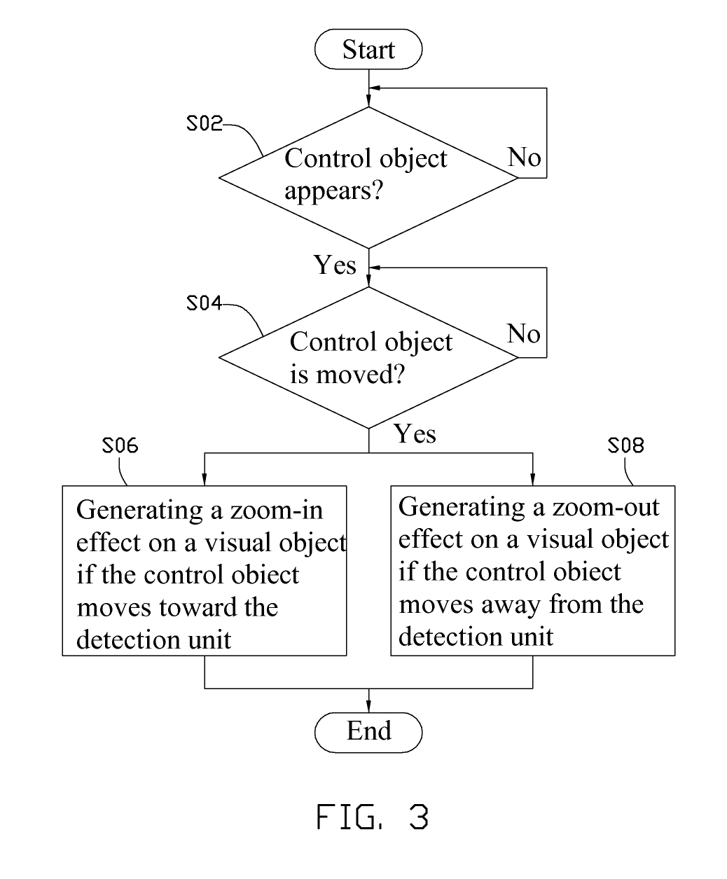

Referring to FIG. 1-3 at the same time, FIG. 3 is a flowchart illustrating a method providing zoom function on the visual object 12 displayed on the screen 1. Depending on the embodiment, additional blocks in the flow of FIG. 3 may be added, others removed, and the ordering of the blocks may be changed.

In block S02, the determination unit 60 determines whether the control object 11 appears in a detection range of the detection unit 40. If the control object 11 does not appear in the detection range, block S02 is repeated.

In block S04, the determination unit 60 determines whether the control object 11 moves relative to the detection unit 40. If the control object 11 does not move relative to the detection unit 40, block S04 is repeated.

In block S06, the zoom unit 70 generates the zoom-in effect on the visual object 12 if the control object 11 moves toward the detection unit 40. The visual object 12 will be magnified due to the zoom-in effect.

In block S08, the zoom unit 70 generates the zoom-out on effect on the visual object 12 if the control object 11 moves away from the detection unit 40. The visual object 12 will be made smaller due to the zoom-out effect.

The present disclosure provides zoom function on visual objects displayed on a screen of a portable device without employing a touch panel. Additional costs associated with the touch panel are avoided.

Although certain inventive embodiments of the present disclosure have been specifically described, the present disclosure is not to be construed as being limited thereto. Various changes or modifications may be made to the present disclosure without departing from the scope and spirit of the present disclosure.

What is claimed is:

1. A computer-implemented method to zoom on a visual object displayed on a screen using a detection unit and a control object, the method comprising:
determining whether the control object appears in a detection range of the detection unit;
determining whether the control object moves relative to the detection unit; and
zooming on the visual object when the control object moves relative to the detection unit.

2. The method of claim 1, wherein the step of zooming on the visual object further comprises:
calculating a first pixel number of a color area of the control object;
calculating a second pixel number of the color area of the control object within a time interval after calculating the first pixel number; and
comparing the second pixel number with the first pixel number.

3. The method of claim 2, wherein the step of zooming on the visual object further comprises:
determining that the control object moves toward the detection unit when the second pixel number exceeds the first pixel number.

4. The method of claim 2, wherein the step of zooming on the visual object comprises:
determining that the control object moves away from the detection unit when the first pixel number exceeds the second pixel number.

5. The method of claim 3, wherein the step of zooming on the visual object further comprises:
generating a zoom-in effect on the visual object if the control object moves toward the detection unit.

6. The method of claim 4, wherein the step of zooming on the visual object on the visual object further comprises:
generating a zoom-out effect on the visual object if the control object moves away from the detection unit.

7. A system to provide a zoom function for a visual object displayed on a screen using a control object, the system comprising:
a detection unit operable to detect the control object;
a storage unit;
at least one processor;
one or more programs stored in the storage unit and being executable by the at least one processor;
a determination unit operable to determine a movement of the control object; and
a zoom unit operable to generate the zoom function on the visual object based on the movement of the control object.

8. The system of claim 7, wherein the system further comprises a calculation unit operable to:
calculate a first pixel number of a color area of the control object;
calculate a second pixel number of the color area of the control object within a time interval after calculating the first pixel number; and
compare the second pixel number with the first pixel number.

9. The system of claim 8, wherein the determination unit is further operable to determine that the control object moves toward the detection unit when the second pixel number exceeds the first pixel number.

10. The system of claim 8, wherein the determination unit is further operable to determine that the control object moves away from the detection unit when the first pixel number exceeds the second pixel number.

11. The system of claim 9, wherein the zoom unit generates a zoom-in effect on the visual object when the control object moves toward detection unit.

12. The system of claim 10, wherein the zoom unit generates a zoom-out effect on the visual object when the control object moves away from the detection unit.

13. A storage medium having stored thereon instructions that, when executed by a processor, causing the processor to perform a method to zoom on a visual object displayed on a screen using a detection unit and a control object, wherein the method comprises:
determine whether the control object appears in a detection range of the detection unit;
determine whether the control object moves relative to the detection unit; and
zoom on the visual object when the control object moves relative to the detection unit.

14. The storage medium of claim 13, wherein the step of zooming on the visual object further comprises:
calculate a first pixel number of a color area of the control object;
calculate a second pixel number of the color area of the control object within a time interval after calculating the first pixel number; and
compare the second pixel number with the first pixel number.

15. The storage medium of claim 13, wherein the step of zooming on the visual object further comprises:
determine that the control object moves toward the detection unit when the second pixel number exceeds the first pixel number.

16. The storage medium of claim 13, wherein the step of zooming on the visual object comprises:
determine that the control object moves away from the detection unit when the first pixel number exceeds the second pixel number.

17. The storage medium of claim 14, wherein the step of zooming on the visual object further comprises:
generate a zoom-in effect on the visual object if the control object moves toward the detection unit.

18. The storage medium of claim 15, wherein the step of zooming on the visual object on the visual object further comprises:
generate a zoom-out effect on the visual object if the control object moves away from the detection unit.
